(19) United States
(12) Patent Application Publication
(10) Pub. No.: US 2026/0124861 A1
(43) Pub. Date: May 7, 2026

(54) COMPONENT CONVEYANCE DEVICE, CARRIAGE, AND METHOD FOR COUPLING CARRIAGE AND TOWING DEVICE

(71) Applicant: FUJI CORPORATION, Chiryu (JP)

(72) Inventor: Yoshihiro FUJITA, Chiryu-shi (JP)

(73) Assignee: FUJI CORPORATION, Chiryu (JP)

(21) Appl. No.: 19/118,015

(22) PCT Filed: Oct. 31, 2022
(86) PCT No.: PCT/JP2022/040700

§ 371 Date: Apr. 3, 2025

(51) Int. Cl. B60D 1/01; B60D 1/00; B66F 9/065

(52) U.S. Cl. CPC B60D 1/01; B66F 9/065; B60D 2001/005

(57) ABSTRACT

A component conveyance device includes a carriage, a towing device, and a connecting portion. The carriage conveys a component which is to be used in a substrate work machine configured to perform a predetermined substrate work on a substrate. The towing device tows the carriage. The connecting portion electrically connects the carriage and the towing device in accordance with positioning and coupling between the carriage and the towing device.

### TECHNICAL FIELD

The present description discloses a technique related to a component conveyance device, a carriage, and a method for coupling the carriage and a towing device.

### BACKGROUND ART

A conveyance vehicle described in Patent Literature 1 includes a first transfer device and a traveling device. The conveyance vehicle is moved to a target station by the traveling device and sends out a component or an accommodation case to the target station by the first transfer device. The conveyance vehicle can also receive the component or the accommodation case from the target station by the first transfer device.

A lifting mechanism described in Patent Literature 2 may include one or more couplers for providing electrical, optical, and mechanical connection between a robot and a tool. Further, the lifting mechanism causes the robot to communicate with the tool, supply power to the tool, and perform tasks such as coupling with the tool.

### CITATION LIST

### Patent Literature

Patent Literature 1: WO 2021/144866
Patent Literature 2: JP-A-2018-513817

### BRIEF SUMMARY

### Technical Problem

However, Patent Literature 1 does not describe a specific connection form between the first transfer device and the traveling device. In addition, Patent Literature 2 does not explicitly describe the coordination of positioning, coupling, and electrical connection between the robot and the tool.

In view of such circumstances, the present description discloses a component conveyance device capable of coordinating positioning, coupling, and electrical connection between a carriage and a towing device, a carriage, and a method for coupling the carriage and the towing device.

### Solution to Problem

The present description discloses a component conveyance device including a carriage, a towing device, and a connecting portion, The carriage is configured to convey a component to be used in a substrate work machine configured to perform a predetermined substrate work on a substrate. The towing device is configured to tow the carriage. The connecting portion is configured to electrically connect the carriage and the towing device in accordance with positioning and coupling between the carriage and the towing device.

The present description discloses a carriage including a delivery mechanism, a coupling mechanism, and a connecting portion. The delivery mechanism is configured to perform delivery of a component to be used in a substrate work machine configured to perform a predetermined substrate work on a substrate, The coupling mechanism is configured to be mechanically coupled to the towing device. The connecting portion is configured to be electrically connected to the towing device, and is electrically connected to the towing device in accordance with positioning and coupling with the towing device.

Furthermore, the present description discloses a method for coupling a carriage configured to convey a component to be used in a substrate work machine configured to perform a predetermined substrate work on a substrate and a towing device that is capable of towing the carriage and automatically moving along a traveling path, The method for coupling the carriage and the towing device includes a first positioning step and a coupling and connection step. The first positioning step performs a first-stage positioning with respect to the carriage. The coupling and connection step, after the first positioning step is performed, operates a moving mechanism, thereby performing mechanical positioning and coupling, and electrically connects the carriage and the towing device in accordance with the positioning and the coupling between the carriage and the towing device.

### Advantageous Effects

With the component conveyance device described above, it is possible to electrically connect the carriage and the towing device in accordance with positioning and coupling between the carriage and the towing device. The above description of the component conveyance device can be similarly applied to a carriage and a method for coupling the carriage and the towing device.

### BRIEF DESCRIPTION OF DRAWINGS

FIG. 1 is a plan view illustrating a configuration example of a production facility,

FIG. 2 is a partial perspective view illustrating a configuration example of a station and a carriage.

FIG. 3 is a perspective view illustrating a state where an accommodation case capable of accommodating a component is loaded on the carriage in FIG. 2.

FIG. 4 is a partial transparent perspective view illustrating a configuration example of a coupling mechanism.

FIG. 5 is a block diagram illustrating an example of a control block of a component conveyance device.

FIG. 6 is a plan view illustrating an example of a positioned portion.

FIG. 7A is an enlarged view of two positioned portions on a right side of the drawing of FIG. 6.

FIG. 7B is a cross-sectional view of the two positioned portions on the right side of the drawing of FIG. 6.

FIG. 8 is a plan view illustrating an example of a positioning portion.

FIG. 9 is a front view illustrating an example of the positioning portion and a moving mechanism illustrated in FIG. 8.

FIG. 10 is a plan view illustrating an example of a state before a protrusion portion is moved toward a hole portion.

FIG. 11 is a plan view illustrating an example of a state after the protrusion portion is fitted into the hole portion.

FIG. 12 is a plan view illustrating a second example of the positioned portion.

FIG. 13 is a plan view illustrating a second example of the positioning portion.

FIG. 14 is a side view illustrating a configuration example of a connecting portion.

FIG. 15 is a flowchart illustrating an example of a coupling procedure.

### DESCRIPTION OF EMBODIMENTS

### 1. Embodiment

### 1-1. Configuration Example of Production Facility 1

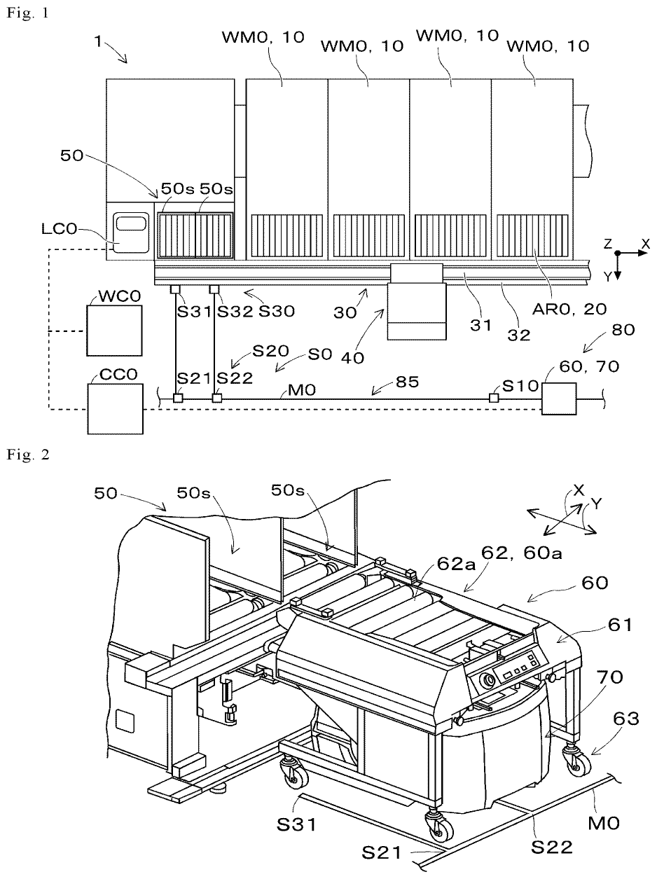

Component conveyance device 80, carriage 60, a method for coupling carriage 60 and towing device 70 can be applied to various production facilities 1 for producing substrate products. As illustrated in FIG. 1, production facility 1 of the embodiment includes at least one component mounter 10 (four in FIG. 1), exchange system 30, component movement device 40, station group 50, carriage 60, towing device 70, line control device LC0, production management device WC0, and conveyance management device CC0, In the following description, a conveyance direction of the substrate, which is a horizontal width direction of component mounter 10, is defined as the X direction. In addition, a direction perpendicular to the X direction in the horizontal plane, which is a horizontal depth direction of component mounter 10, is defined as the Y direction. Furthermore, a vertical direction perpendicular to the X direction and the Y direction is defined as the Z direction.

At least one (or four) component mounter(s) 10 is installed along the conveyance direction of the substrate (X direction). Component mounter 10 is included in substrate work machine WM0 that performs a predetermined substrate work on the substrate. Component mounter 10 mounts multiple components on a substrate, which is conveyed in and positioned at a predetermined position, and conveys out the substrate on which the components are mounted. That is, the substrate work performed by component mounter 10 includes conveying-in, positioning, and conveying-out work of the substrate. Further, the substrate work by component mounter 10 includes component supply work, collection work, and mounting work. Substrate work machine WM0 is not limited to component mounter 10. but may be a device such as a printing machine that prints solder on a substrate, an inspection machine for inspecting a substrate on which solder is printed or a substrate on which components are mounted, and a reflow oven for heating a substrate on which the components are mounted to bond the components to the substrate.

For example, component mounter 10 includes a component supply device that supplies components to be mounted on the substrate. Multiple feeders 20 are detachably provided in the component supply device. Feeder 20 is included in component ARO to be used in the component supply work by component mounter 10. Further, the component supply device includes at least one slot capable of installing multiple feeders 20. The component supply device of the embodiment is provided at two positions of a first position and a second position.

The first position operably holds installed feeder 20. The operation of feeder 20 installed in the first position is controlled in the substrate work by component mounter 10, and the components are sequentially supplied by a pick-up section provided at a predetermined position of feeder 20. The second position is disposed below the first position and stocks installed feeder 20. That is, the second position preliminarily holds feeder 20 used for production and temporarily holds feeder 20 that has been used for production.

An exchange operation of feeder 20 between the first position and the second position, and a replenishment operation and a retrieval operation of feeder 20 are performed using exchange system 30 and component movement device 40. Specifically, as illustrated in FIG. 1, exchange system 30 includes first rail 31 and second rail 32. First rail 31 and second rail 32 form a traveling path of component movement device 40. First rail 31 and second rail 32 are provided along a disposition direction of at least one (or four) component mounter(s) 10 (the conveyance direction (X direction) of the substrate). First rail 31 and second rail 32 extend over substantially the entire area of the conveyance direction (X direction) of the substrate in production facility 1.

Component movement device 40 is provided so as to be able to travel along the traveling path formed by first rail 31 and second rail 32. Component movement device 40 receives power from a power transmitting section by non-contact power supply, for example, via a power receiving section provided to face the power transmitting section provided on first rail 31. The power received by the power receiving section is used for traveling of component movement device 40, a predetermined operation, or the like via a power receiving circuit. It is noted that component movement device 40 detects, for example, a position (current position) on the traveling path by a position detection device. The position detection device can detect the position (current position) of component movement device 40 on the traveling path, for example, by optical position detection, position detection using electromagnetic induction, or the like.

Further, the predetermined operation described above includes an exchange operation for exchanging a device detachably provided in substrate work machine WM0, such as component mounter 10, with substrate work machine WM0. In the embodiment, component movement device 40 uses feeder 20 that supplies the components to be mounted on the substrate as a device and performs the exchange operation of feeder 20 with component mounter 10, which is substrate work machine WM0. Further, component movement device 40 can perform the exchange operation of feeder 20 with station group 50.

Specifically, component movement device 40 performs the exchange operation of feeder 20 between the first position and the second position of the component supply device of component mounter 10. Further, component movement device 40 conveys feeder 20 from station group 50 to the first position or the second position of the component supply device and performs the replenishment operation of feeder 20. Further, component movement device 40 conveys feeder 20, which is made unnecessary in component mounter 10, from the component supply device to station group 50 and performs the retrieval operation of feeder 20.

Station group 50 is provided on a substrate convey-in side (on the left side of the drawing of FIG. 1) of production facility 1. As illustrated in FIGS. 1 and 2, station group 50 is provided with at least one station 50s (two in FIGS. 1 and 2) capable of delivering component AR0 to be used in substrate work machine WM0, such as feeder 20. Station 50s needs only to be capable of delivering component AR0, and can take various forms. For example, station 50s includes multiple rollers, and can convey in component AR0 from carriage 60 and convey out component AR0 to carriage 60.

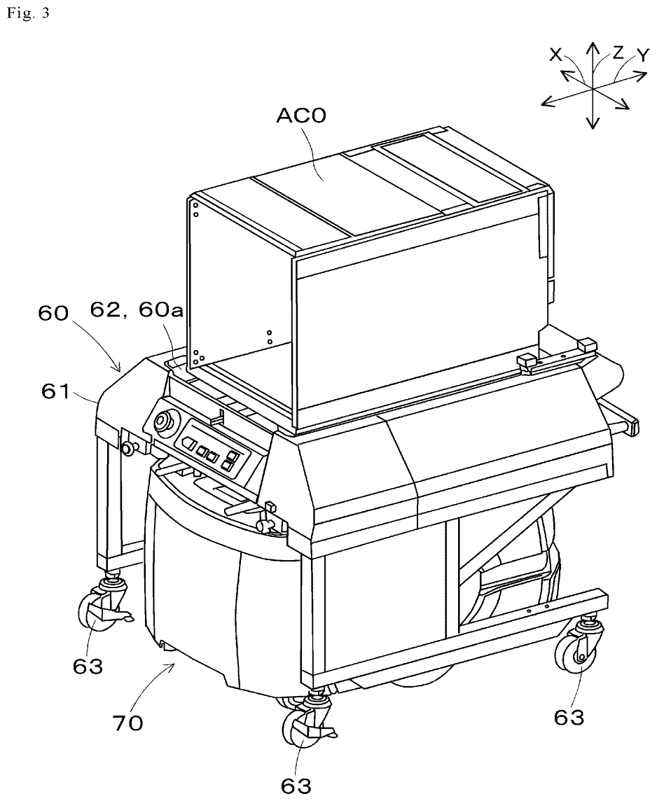

Station 50s can also house accommodation case AC0 illustrated in FIG. 3 capable of accommodating component AR0. In this case as well, station 50s can convey in accommodation case AC0 from carriage 60 and convey out accommodation case AC0 to carriage 60 by multiple rollers. Accommodation case AC0 includes, for example, multiple slots, and feeder 20 can be provided in each slot. Feeder 20, which is installed in the slot of accommodation case AC0 conveyed in station 50s, is supplied with power from station 50s, via accommodation case AC0 and then becomes in a state capable of communicating with line control device LC0. As a result, identification information of the slot of accommodation case ACO and feeder 20, which is installed in the slot, are associated with each other and recorded in line control device LC0.

Carriage 60 conveys component AR0 to be used in substrate work machine WM0, Carriage 60 of the embodiment conveys in or conveys out component AR0 to or from station 50s. The conveyance of component AR0 by carriage 60 is not limited to only station 50s, and if possible, component AR0 may also be directly conveyed in or conveyed out of substrate work machine WM0. Carriage 60 needs only to be able to convey component AR0, and can take various forms. For example, as illustrated in FIGS. 2 and 3, carriage 60 includes carriage main body section 61, loading platform 62, and multiple (for example, four) wheels 63. Loading platform 62 is provided at the upper portion of carriage main body section 61, and can be loaded with component AR0. As illustrated in FIG. 3, loading platform 62 can be loaded with accommodation case AC0 capable of accommodating component AR0.

Loading platform 62 includes multiple rollers 62a, and can convey in component AR0 to station 50s and convey out component AR0 from station 50s. Further, loading platform 62 can convey in accommodation case AC0 to station 50s and convey out accommodation case AC0 from station 50s. Loading platform 62 fixes component AR0 or accommodation case AC0 except when component AR0 or accommodation case AC0 is conveyed in or conveyed out of station 50s. Loading platform 62 releases the fixation of component AR0 or accommodation case AC0 when component AR0 or accommodation case AC0 is conveyed in or conveyed out of station 50s.

Multiple (four) wheels 63 are provided on the bottom of carriage main body section 61, and carriage 60 travels by being towed by towing device 70. Specifically, in a state in which towing device 70 is disposed below carriage main body section 61, towing device 70 is coupled to carriage main body section 61 so as to be able to tow carriage 60. Towing device 70 needs only to be capable of automatic travel, and is not limited to any specific type. Towing device 70 can use, for example, a known automatic guided vehicle (AGV), an autonomous mobile robot (AMR), or the like.

Line control device LC0 has a configuration that enables input and output of various data to and from each device constituting production facility 1 via a network. Line control device LC0 monitors an operational status of production facility 1 and controls substrate work machine WM0, such as component mounter 10, exchange system 30, component movement device 40, and station group 50. Line control device LC0 stores various data for controlling substrate work machine WM0, exchange system 30, component movement device 40, and station group 50.

Production management device WC0 can manage at least one (in FIG. 1, one) production facility 1. Production management device WC0 is provided to be able to communicate with line control device LC0 of at least one (one) production facility 1, and manages the production of substrate products by at least one (one) production facility 1. Conveyance management device CC0 can manage carriage 60 and towing device 70. Conveyance management device CC0 is provided to be able to communicate with carriage 60, towing device 70, line control device LC0, and production management device WC0, and based on the production status of substrate products in production facility 1, conveyance management device CC0 causes carriage 60 and towing device 70 to travel and causes carriage 60 to perform the delivery of component AR0.

For example, when towing device 70 is an autonomous mobile robot, towing device 70 can move while recognizing the position of towing device 70 itself in production facility 1 using a known camera, a sensor, or the like. When towing device 70 is an automatic guided vehicle, towing device 70 can move, for example, by guide portion 85. Towing device 70 of the embodiment is an automatic guided vehicle, and as illustrated in FIG. 1, production facility 1 is provided with guide portion 85.

Guide portion 85 is a member provided along the traveling path of carriage 60 and towing device 70, and guides the travel of carriage 60 and towing device 70. Specifically, towing device 70 that tows carriage 60 travels while recognizing guide portion 85. For example, guide portion 85 includes guide member M0 indicating the traveling path of carriage 60 and towing device 70, and indicator member S0 serving as an indicator during travel. Guide member M0 and indicator member S0 improve the traveling accuracy of carriage 60 and towing device 70.

Guide member M0 and indicator member S0 can take various forms. In the embodiment, guide member M0 and indicator member S0 are formed of magnetic tape. Towing device 70 towing carriage 60 can prevent carriage 60 and towing device 70 from departing from the traveling path to be traveled by traveling while sensing guide member M0. Towing device 70 can recognize the traveling position of carriage 60 and towing device 70 by sensing indicator member S0.

For example, indicator member S0 includes a reference member indicating reference position S10, a via member indicating via position S20, and a target member indicating target position S30. In addition, since station group 50 of the embodiment includes two stations 50s, the via member includes a first via member indicating first via position S21 and a second via member indicating second via position S22. The target member includes a first target member indicating first target position S31 and a second target member indicating second target position S32.

For example, towing device 70 towing carriage 60 recognizes that carriage 60 and towing device 70 are traveling at first via position S21 by sensing the first via member. For example, when at least one of carriage 60 and towing device 70 and conveyance management device CC0 communicate with each other, conveyance management device CC0 can recognize the traveling position of at least one of carriage 60 and towing device 70, indicator member S0 may be omitted.

Towing device 70 towing carriage 60 travels toward target station 50s along a traveling path that is programmed in advance or a traveling path instructed by conveyance management device CC0. For example, consider the case where station 50s on the left side of the drawing illustrated in FIG. 1 is target station 50s, and towing device 70 towing carriage 60 moves from reference position S10 to first target position S31. In this case, when towing device 70 towing carriage 60 senses the first via member, towing device 70 rotates 90 degrees to the right and moves straight ahead. Then, towing device 70 towing carriage 60 stops when the first target member is sensed.

The same applies when station 50s on the right side of the drawing illustrated in FIG. 1 is target station 50s, and towing device 70 towing carriage 60 is moved from reference position S10 to second target position S32. In this case, when towing device 70 towing carriage 60 senses the second via member, towing device 70 rotates 90 degrees to the right and moves straight ahead. Then, towing device 70 towing carriage 60 stops when the second target member is sensed. Towing device 70 towing carriage 60 can sense station 50s when the distance between towing device 70 and station 50s becomes equal to or shorter than a predetermined distance, and can stop even when the first target member or the second target member is not sensed.

When arriving at target station 50s, carriage 60 sends component AR0 or accommodation case AC0 out to station 50s, and station 50s receives component AR0 or accommodation case AC0 from carriage 60. Further, station 50s can send component AR0 or accommodation case AC0 out to carriage 60, and carriage 60 can receive component AR0 or accommodation case AC0 from station 50s.

Further, carriage 60 can also send component AR0 or accommodation case AC0 out to first station 50s, move to second station 50s, and receive component AR0 or accommodation case AC0 from second station 50s. Further, carriage 60 can receive component AR0 or accommodation case AC0 from first station 50s, move to second station 50s, and send component AR0 or accommodation case AC0, received from first station 50s, out to second station 50s. Component AR0 can be delivered in a state of being accommodated in accommodation case AC0, and can be delivered in a state not accommodated in accommodation case AC0.

### 1-2. Configuration Example Related to Positioning and Coupling of Carriage 60 and Towing Device 70

As illustrated in FIG. 4, coupling mechanism 60b is disposed between bottom plate 64 at the lower portion of loading platform 62 and the upper surface of towing device 70. Coupling mechanism 60b is configured to couple carriage main body section 61 to towing device 70 that has entered below carriage main body section 61 so as to be able to tow carriage main body section 61. Coupling mechanism 60b includes multiple (for example, three) coupling pins provided on the upper surface of towing device 70, advancing direction-side locking member 65 provided on bottom plate 64 of loading platform 62, pair of switching mechanisms 66, 66, and pair of guide members 67, 67. In FIG. 4, bottom plate 64 is shown in a transparent view for convenience of description.

As illustrated in FIG. 4, advancing direction-side coupling pin 71 is provided at a position that is close to the center in the width direction of the upper surface of towing device 70 and on the advancing direction side. Advancing direction-side coupling pin 71 is formed by, for example, fitting a cylindrical urethane rubber on the outer peripheral side of a metallic round bar. Further, pair of retreating direction-side coupling pins 72, 72 are provided at positions that are close to both end portions in the width direction of the upper surface of towing device 70 and on the retreating direction side. Retreating direction-side coupling pin 72 is made of the same material and is formed in the same shape as advancing direction-side coupling pin 71. Retreating direction-side coupling pin 72 is attached to the upper surface of towing device 70 via spacer 73, and is disposed at a position higher than advancing direction-side coupling pin 71.

An advancing direction-side edge portion and a retreating direction-side edge portion of bottom plate 64 of loading platform 62 are bent downward. Advancing direction-side locking member 65 is provided at a position that is close to the center in the width direction of the lower surface of bottom plate 64 and on the advancing direction side. Advancing direction-side locking member 65 is formed in a crank shape in a plan view, and includes an accommodation section that opens in the retreating direction. The accommodation section of advancing direction-side locking member 65 includes a narrowest portion at a predetermined height position, and includes an inner wall surface with a tapered shape that extends in the vertical direction. The opening width dimension in the narrowest portion of advancing direction-side locking member 65 is set to be substantially equal to the diameter of advancing direction-side coupling pin 71.

When towing device 70 enters below carriage main body section 61, advancing direction-side coupling pin 71 enters the accommodation section of advancing direction-side locking member 65, moving from the retreating direction side to the advancing direction side of towing device 70. Advancing direction-side coupling pin 71 is inscribed in the narrowest portion of advancing direction-side locking member 65 and is not in substantially contact with the inner wall surface other than the narrowest portion. Further, when advancing direction-side coupling pin 71 is inscribed in the narrowest portion, the urethane rubber on the outer peripheral side is allowed to be slightly deformed. Accordingly. the accommodation section of advancing direction-side locking member 65 locks advancing direction-side coupling pin 71 and restricts the movement in the width direction. As a result. the position of carriage main body section 61 in the width direction with respect to towing device 70 is determined.

Further, the accommodation section of advancing direction-side locking member 65 allows for tilting of advancing direction-side coupling pin 71 in the width direction and the advancing and retreating direction (the direction perpendicular to the width direction in the horizontal plane, and similarly hereafter). Therefore, towing device 70 and carriage 60 can move smoothly, even if, for example, undulations occur on the floor surface. Advancing direction-side coupling pin 71 is relatively movable in the advancing and retreating direction inside the accommodation section of advancing direction-side locking member 65.

Pair of guide members 67, 67 are provided below bottom plate 64. Each of pair of guide members 67, 67 is formed in a bar shape or a plate shape. Pair of guide members 67, 67 are disposed to gradually approach the accommodation section of advancing direction-side locking member 65 from the retreating direction side of loading platform 62 to the advancing direction side. Pair of guide members 67, 67 guide advancing direction-side coupling pin 71 toward the accommodation section of advancing direction-side locking member 65 to eliminate misalignment between carriage 60 and towing device 70 when towing device 70 enters below carriage main body section 61.

Bottom plate 64 includes crank edge portion 64a and pair of retreating direction-side edge portions 64b, 64b. Crank edge portion 64a is the edge portion on the retreating direction side of bottom plate 64, and the central portion of crank edge portion 64a is cut out in a crank shape. Pair of retreating direction-side edge portions 64b, 64b are portions which are not cut out, and pair of switching mechanisms 66, 66 are provided. Each of pair of switching mechanisms 66, 66 includes mechanism main body 66a, retreating direction-side locking member 66b, and operation knob 66c.

Mechanism main body 66a is fixed to retreating direction-side edge portion 64b. Retreating direction-side locking member 66b is a plate-shaped member that is bent in a mountain shape. As indicated by arrow A1 in FIG. 4, retreating direction-side locking member 66b is supported by mechanism main body 66a to be slidable in the width direction. In other words, retreating direction-side locking member 66b is supported to be movable between a locking position where retreating direction-side locking member 66b protrudes from mechanism main body 66a in the direction of the center line and a non-locking position where retreating direction-side locking member 66b is housed in mechanism main body 66a. In the initial state of pair of switching mechanisms 66, 66, retreating direction-side locking member 66b is located at the non-locking position. Operation knob 66c is provided in mechanism main body 66a. By rotating operation knob 66c, retreating direction-side locking member 66b moves between the non-locking position and the locking position.

When retreating direction-side locking member 66b is at the non-locking position, retreating direction-side locking member 66b allows retreating direction-side coupling pin 72 to pass through in the advancing and retreating direction, and allows towing device 70 to enter and exit below carriage main body section 61. As illustrated in FIG. 4, when towing device 70 enters below carriage main body section 61 and advancing direction-side coupling pin 71 is locked to advancing direction-side locking member 65, pair of retreating direction-side coupling pins 72, 72 enter the inside of the crank shape of crank edge portion 64a and protrude to a position above crank edge portion 64a.

When the worker rotates operation knob 66c, retreating direction-side locking member 66b slides from the non-locking position to the locking position and is positioned behind retreating direction-side coupling pin 72, When retreating direction-side locking member 66b is at the locking position, retreating direction-side locking member 66b restricts the passage of retreating direction-side coupling pin 72 in the retreating direction, and can restrict the exit of towing device 70 from below carriage main body section 61.

When retreating direction-side locking member 66b is at the locking position, a gap corresponding to a clearance dimension in the advancing and retreating direction is generated between retreating direction-side coupling pin 72 and crank edge portion 64a and between retreating direction-side coupling pin 72 and retreating direction-side locking member 66b. That is, crank edge portion 64a and retreating direction-side locking member 66b lock retreating direction-side coupling pin 72 to be relatively movable in the advancing and retreating direction within a range of a predetermined clearance dimension. Therefore, both advancing direction-side coupling pin 71 and retreating direction-side coupling pin 72 are relatively movable in the advancing and retreating direction. With this, the position of carriage main body section 61 in the advancing and retreating direction with respect to towing device 70 is not determined.

Further, a gap corresponding to the clearance dimension in the width direction is formed between retreating direction-side coupling pin 72 and crank edge portion 64a. That is, crank edge portion 64a functions as a locking member that locks retreating direction-side coupling pin 72 to be relatively movable within the range of the clearance dimension in the width direction, With this, the portion of carriage main body section 61 on the retreating direction side can rotate in the width direction about advancing direction-side coupling pin 71. In other words, the posture change of carriage main body section 61 with respect to towing device 70 is allowed.

Thereafter, the coupling between carriage 60 and towing device 70, which will be described later, is performed, and the coupling process of carriage 60 and towing device 70 ends. When towing device 70 moves in the advancing direction while towing carriage 60, advancing direction-side coupling pin 71 presses advancing direction-side locking member 65. When towing device 70 moves in the retreating direction while towing carriage 60, retreating direction-side coupling pin 72 presses retreating direction-side locking member 66b.

### 1-3. Configuration Example of Component Conveyance Device 80

As described above, the positioning (first-stage positioning) between carriage 60 and towing device 70 is performed. Thereafter, carriage 60 and towing device 70 can perform mechanical positioning and coupling by moving mechanism 100, which will be described later. However, electrical connection between carriage 60 and towing device 70 is required. When the worker performs electrical connection work, the work amount of the worker increases as compared with the case where the connection work is automated. In addition, when the worker performs the electrical connection work, there is a possibility of errors such as incorrect connections or poor connections. Further, when the worker performs coupling work between carriage 60 and towing device 70, there is a possibility that the worker may only perform the coupling work and forget the electrical connection work.

Production facility 1 is provided with component conveyance device 80. Component conveyance device 80 electrically connects carriage 60 and towing device 70 in accordance with the positioning and the coupling between carriage 60 and towing device 70. As illustrated in FIG. 5, component conveyance device 80 includes carriage 60, towing device 70, and connecting portion 80c. A broken line shown in FIG. 5 schematically illustrates the positioning and the coupling between carriage 60 and towing device 70.

Carriage 60 needs only to be able to convey component ARO to be used in substrate work machine WM0, and can take various forms. Similarly, towing device 70 needs only to be capable of towing carriage 60, and can take various forms, Carriage 60 of the embodiment conveys feeder 20 or accommodation case AC0 accommodating feeder 20. Further, carriage 60 includes, for example, a carriage capable of conveying a mask to be used in a printing machine that prints solder on a substrate. Further, carriage 60 includes, for example, a carriage capable of conveying a tray component arranged on a tray, a wafer or the like. Feeder 20, the mask, the tray component, and the wafer are included in component AR0.

Connecting portion 80c electrically connects carriage 60 and towing device 70 in accordance with the positioning and the coupling between carriage 60 and towing device 70. Connecting portion 80c needs only to perform the electrical connection as described above, and can take various forms. For example, a first one of carriage 60 and towing device 70 is referred to as first device 81, and a second one of carriage 60 and towing device 70 is referred to as second device 82.

In this case, first device 81 may include positioning portion 91 that positions second device 82, and second device 82 includes positioned portion 92 that is positioned by positioning portion 91 of first device 81. In addition, first device 81 or second device 82 may include moving mechanism 100 configured to move positioned portion 92 along contact surface 93 between positioning portion 91 and positioned portion 92 by causing relative movement between positioning portion 91 and positioned portion 92, thereby performing the positioning and the coupling.

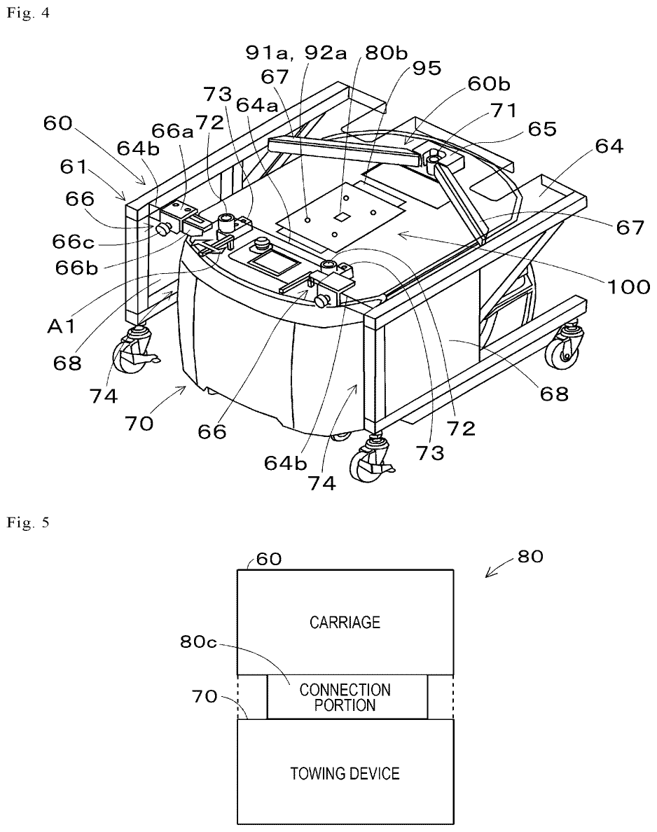

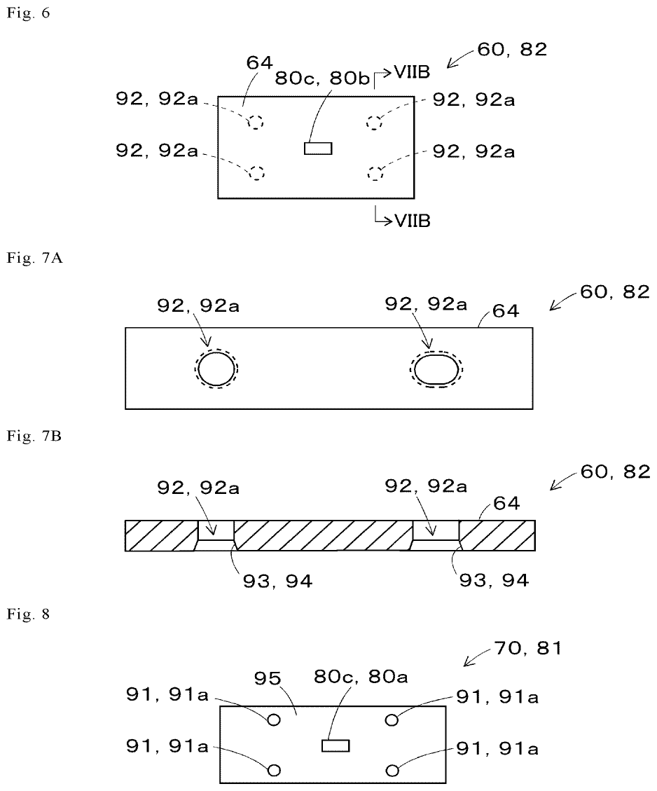

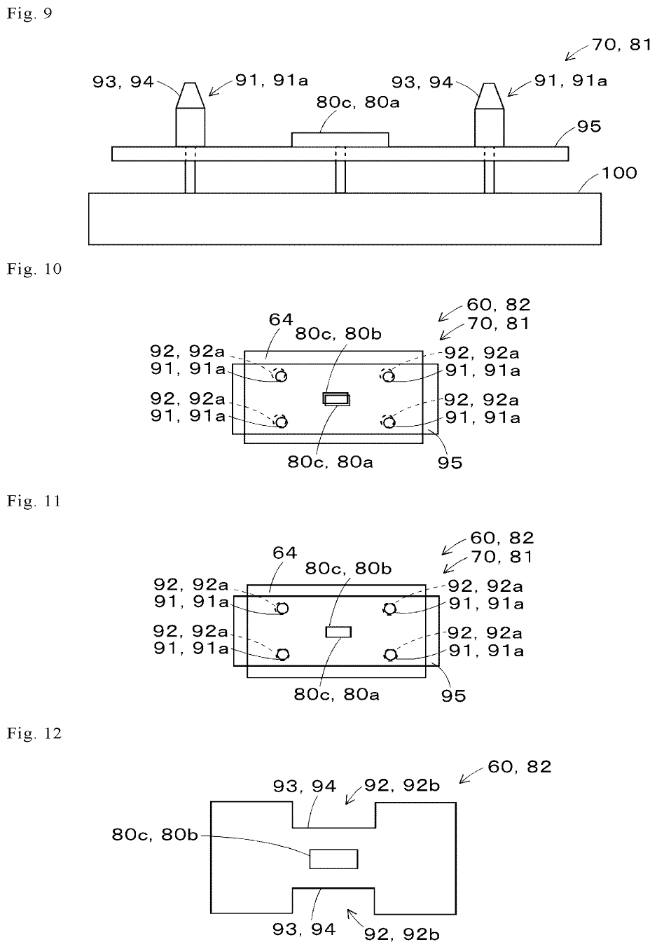

In the embodiment, first device 81 is towing device 70, and second device 82 is carriage 60. As illustrated in FIGS. 6, 7A, and 7B, positioned portion 92 provided in carriage 60 is hole portion 92a provided in an outer plate (for example, bottom plate 64 of carriage 60 illustrated in FIG. 4) of second device 82. Hole portion 92a has, for example, a circular shape or an elongated hole shape. As illustrated in FIGS. 8 and 9, positioning portion 91 provided in towing device 70 is protrusion portion 91a that can be fitted into circular hole portion 92a. Protrusion portion 91a is provided on base member 95, and has, for example, a tip end portion of a round pin formed in a mountain shape. Base member 95 is provided at a portion on first device 81 side facing the outer plate of second device 82.

Moving mechanism 100 of the embodiment is provided in towing device 70 that is first device 81. In addition, moving mechanism 100 is configured to move protrusion portion 9 la toward hole portion 92a to fit protrusion portion 91a into hole portion 92a, thereby performing the positioning and the coupling between carriage 60 and towing device 70. As moving mechanism 100, for example, a known lifting and lowering mechanism, slide mechanism, or the like can be used. FIG. 10 illustrates an example of a state before protrusion portion 91a is moved toward hole portion 92a. The center position of protrusion portion 91a and the center position of hole portion 92a are slightly misaligned from each other due to the misalignment between carriage 60 and towing device 70.

Moving mechanism 100 is configured to lift protrusion portion 91a and move protrusion portion 91a toward hole portion 92a. When protrusion portion 91a fits into hole portion 92a, relative movement occurs between protrusion portion 91a and hole portion 92a. Specifically, hole portion 92a moves along the tip end portion of protrusion portion 91a, which is contact surface 93 between protrusion portion 91a and hole portion 92a, and carriage 60 moves together with bottom plate 64. FIG. 11 illustrates an example of a state after protrusion portion 91a is fitted into hole portion 92a. When protrusion portion 91a is fitted into hole portion 92a, the center position of protrusion portion 91a and the center position of hole portion 92a align with each other. Accordingly, the positioning and the coupling between carriage 60 and towing device 70 are completed.

Connecting portion 80c includes first connecting portion 80a provided in first device 81 and second connecting portion 80b provided in second device 82. In this case, moving mechanism 100 is configured to position and connect first connecting portion 80a and second connecting portion 80b by the relative movement between positioning portion 91 and positioned portion 92. As illustrated in FIG. 10, in a state before protrusion portion 91a is moved toward hole portion 92a, the center position of first connecting portion 80a and the center position of second connecting portion 80b are slightly misaligned from each other due to the misalignment between carriage 60 and towing device 70.

Moving mechanism 100 is configured to lift first connecting portion 80a along with the lifting of protrusion portion 91a. As illustrated in FIG. 11, the center position of first connecting portion 80a and the center position of second connecting portion 80b align with each other by the relative movement between protrusion portion 91a and hole portion 92a described above. First connecting portion 80a is lifted in this state, whereby first connecting portion 80a and second connecting portion 80b are connected with their center positions aligned. Moving mechanism 100 is also configured to lift first connecting portion 80a after the relative movement described above.

In addition, moving mechanism 100 is also configured to move base member 95 on which protrusion portion 91a is fixed toward hole portion 92a to fit protrusion portion 91a into hole portion 92a, thereby performing the positioning and the coupling between carriage 60 and towing device 70. Moving mechanism 100 can also be provided in carriage 60 that is second device 82. In this case, moving mechanism 100 is configured to move hole portion 92a toward protrusion portion 91a or base member 95 on which protrusion portion 91a is fixed to fit protrusion portion 91a into hole portion 92a, thereby performing the positioning and the coupling between carriage 60 and towing device 70. Moving mechanism 100 is configured, for example, to lower bottom plate 64 of carriage 60 on which hole portion 92a is formed.

In this manner, moving mechanism 100 can be provided in first device 81 or second device 82. In addition, moving mechanism 100 is configured to move a first one of protrusion portion 91a or base member 95 on which protrusion portion 91a is fixed, and hole portion 92a toward a second one thereof to fit protrusion portion 91a into hole portion 92a, thereby performing the positioning and the coupling between carriage 60 and towing device 70. In addition, moving mechanism 100 is configured to position and connect first connecting portion 80a and second connecting portion 80b by the relative movement between protrusion portion 91a and hole portion 92a.

In the embodiment, hole portion 92a is formed in bottom plate 64 of carriage 60. However, the portion where hole portion 92a is formed is not limited to bottom plate 64. For example, hole portion 92a may be formed in pair of side plates 68, 68 provided at both end portions in the width direction of carriage 60 illustrated in FIG. 4. In this case, protrusion portion 91a can be formed in pair of side plates 74, 74 provided at both end portions in the width direction of towing device 70. Moving mechanism 100 can use a slide mechanism that is slidable in the width direction of towing device 70.

Inclined surface 94 that guides the relative movement between positioning portion 91 and positioned portion 92 may be formed on at least one of positioning portion 91 and positioned portion 92. As illustrated in FIG. 7B and FIG. 9, in the embodiment, inclined surface 94 is formed in both protrusion portion 91a that is positioning portion 91 and hole portion 92a that is positioned portion 92. The inclination angle of inclined surface 94 of protrusion portion 91a and the inclination angle of inclined surface 94 of hole portion 92a are the same. As a result, the relative movement between protrusion portion 91a and hole portion 92a is smoother, as compared with the case where inclined surface 94 is not provided.

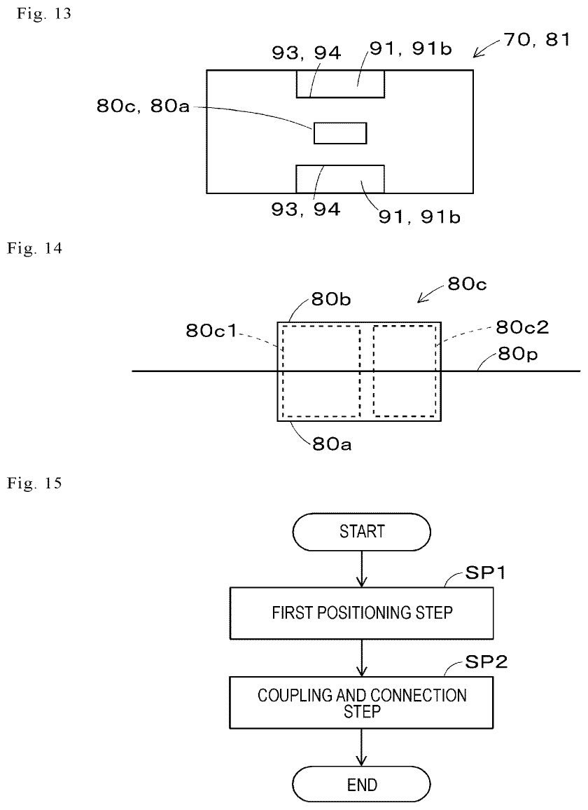

As illustrated in FIGS. 12 and 13, positioned portion 92 may be recessed portion 92b provided in the outer peripheral portion of second device 82, and positioning portion 91 may be plate-shaped member 91b capable of coming into surface contact with recessed portion 92b. For example, first device 81 is towing device 70, and second device 82 is carriage 60. For example, recessed portion 92b is provided in the vicinity of the central portion in the advancing and retreating direction at both end portions in the width direction of carriage 60. Similarly, plate-shaped member 91b is provided in the vicinity of the central portion in the advancing and retreating direction at both end portions in the width direction of towing device 70. Plate-shaped member 91b is formed to extend in the vertical direction (the direction perpendicular to the drawing of FIG. 13).

Inclined surface 94 already described may be formed on at least one of plate-shaped member 91b and recessed portion 92b. As illustrated in FIG. 13, plate-shaped member 91b has inclined surface 94 formed on the surface on first connecting portion 80a side. As illustrated in FIG. 12, recessed portion 92b has inclined surface 94 formed on the surface on second connecting portion 80b side. Moving mechanism 100 is provided, for example, on towing device 70. Moving mechanism 100 is configured to move plate-shaped member 91b with respect to recessed portion 92b while bringing plate-shaped member 91b and recessed portion 92b into surface contact with each other, thereby performing the positioning and the coupling between carriage 60 and towing device 70, Moving mechanism 100 is configured, for example, to lift plate-shaped member 91b and move plate-shaped member 91b toward recessed portion 92b.

When plate-shaped member 91b is further lifted while being in surface contact with recessed portion 92b, relative movement occurs between plate-shaped member 91b and recessed portion 92b. Specifically, recessed portion 92b moves along plate-shaped member 91b, which is contact surface 93 between plate-shaped member 91b and recessed portion 92b, and carriage 60 moves together with recessed portion 92b. Accordingly, the positioning and the coupling between carriage 60 and towing device 70 are completed. For example, recessed portion 92b can be provided at any outer peripheral portion of carriage 60 such as a corner portion or a leg portion of carriage 60, and plate-shaped member 91b can be provided at any position corresponding to the position of recessed portion 92b.

Further, moving mechanism 100 is also configured to move recessed portion 92b with respect to plate-shaped member 91b while bringing plate-shaped member 91b and recessed portion 92b into surface contact with each other, thereby performing the positioning and the coupling between carriage 60 and towing device 70. In this manner, moving mechanism 100 is configured to move a first one of plate-shaped member 91b and recessed portion 92b with respect to a second one thereof while bringing plate-shaped member 91b and recessed portion 92b into surface contact with each other, thereby performing the positioning and the coupling between carriage 60 and towing device 70. In the above configuration as well, moving mechanism 100 is configured to position and connect first connecting portion 80a and second connecting portion 80b by the relative movement between plate-shaped member 91b and recessed portion 92b.

As illustrated in FIG. 6, carriage 60, which is second device 82, includes multiple (for example, four) hole portions 92a that are positioned portions 92. Multiple (four) hole portions 92a are evenly arranged around second connecting portion 80b. As illustrated in FIG. 8, towing device 70, which is first device 81, includes multiple (for example, four) protrusion portions 91a that are positioning portions 91. Multiple (four) protrusion portions 91a are evenly arranged around first connecting portion 80a. The configuration illustrated in FIGS. 12 and 13 differs from the configuration of the embodiment described above in that two sets of positioning portion 91 and positioned portion 92 are provided, but the arrangement of positioning portion 91 and positioned portion 92 can be similarly described.

In this manner, positioning portion 91 and positioned portion 92 may be provided in multiple sets, and the multiple sets of positioning portion 91 and positioned portion 92 may be evenly arranged around connecting portion 80c. Accordingly, the relative movement between positioning portion 91 and positioned portion 92 can be generated at multiple locations around connecting portion 80c, and the positioning and the connection between first connecting portion 80a and second connecting portion 80b become easy. In addition, the external force generated in first connecting portion 80a and second connecting portion 80b can be reduced.

In addition, when two sets of positioning portion 91 and positioned portion 92 are provided, the rotational movement is more likely to occur during the relative movement between positioning portion 91 and positioned portion 92, Therefore, positioning portion 91 and positioned portion 92 may be provided in three or more sets. It is noted that the smaller the area of contact surface 93 between positioning portion 91 and positioned portion 92 is, the more pronounced the above-described effect becomes. Therefore, a configuration including three or more sets of positioning portion 91 and positioned portion 92 may be applied to the case where positioning portion 91 is protrusion portion 91a and positioned portion 92 is hole portion 92a (the configuration illustrated in FIGS. 6 and 8).

In addition, a configuration where positioning portion 91 is plate-shaped member 91b, and positioned portion 92 is recessed portion 92b (the configuration illustrated in FIGS. 12 and 13) can include three or more sets of plate-shaped member 91b and recessed portion 92b, depending on the area of contact surface 93, That is, component conveyance device 80 can include three or more sets of plate-shaped member 91b and recessed portion 92b when the area of contact surface 93 is smaller than the predetermined area.

In the configuration where positioning portion 91 is protrusion portion 91a and positioned portion 92 is hole portion 92a (the configuration illustrated in FIGS. 6 and 8), it is expected that due to variations in manufacturing, the external dimensions of protrusion portion 91a and hole portion 92a may differ from the expected dimensions, making fitting difficult. Therefore, for example, a predetermined set (for example, two sets) of protrusion portions 91a and hole portions 92a can be set to have the same external dimensions as the design dimensions. For other predetermined sets (for example, two sets) of protrusion portions 91a and hole portions 92a, hole portions 92a can be formed, for example, as elongated hole portions, as illustrated in FIGS. 7A and 7B.

Similarly, in the configuration where positioning portion 91 is plate-shaped member 91b and positioned portion 92 is recessed portion 92b (the configuration illustrated in FIGS. 12 and 13), it is expected that due to variations in manufacturing, contact surface 93 between plate-shaped member 91b and recessed portion 92b does not necessarily become a parallel plane. Therefore, for example, a predetermined set (for example, one set) of plate-shaped member 91b and recessed portion 92b can be set to have the same external dimensions as the design dimensions. For other predetermined sets (for example, one set) of plate-shaped member 91b and recessed portion 92b, the external dimensions of plate-shaped member 91b can be set smaller than the design dimensions. Further, for other predetermined sets (for example, one set) of plate-shaped member 91b and recessed portion 92b, the external dimensions of recessed portion 92b can also be set larger than the design dimensions.

As already described, moving mechanism 100 is configured to position and connect first connecting portion 80a and second connecting portion 80b by the relative movement between positioning portion 91 and positioned portion 92. However, there is a possibility that the center position of first connecting portion 80a does not completely align with the center position of second connecting portion 80b. Therefore, connecting portion 80c may be a floating connector. As illustrated in FIG. 14, in the floating connector, first connecting portion 80a is fixed to first device 81 so as not to be relatively movable, and second connecting portion 80b is fixed to second device 82 so as to be relatively movable with respect to plane 80p perpendicular to a connection direction with first connecting portion 80a. Accordingly, connecting portion 80c can eliminate the misalignment between first connecting portion 80a and second connecting portion 80b.

In the present description, an example is described in which first device 81 is towing device 70 and second device 82 is carriage 60, but the matters described in the present description can be similarly applied to the case where first device 81 is carriage 60 and second device 82 is towing device 70. In addition, the matters described in the present description can be appropriately selected and applied, and a combination of the selected forms can also be adopted.

### 1-4. Configuration Example of Carriage 60

As already described, carriage 60 needs only to be able to convey component AR0 to be used in substrate work machine WM0, and can take various forms. For example, carriage 60 includes delivery mechanism 60a, coupling mechanism 60b, and connecting portion 80c. Delivery mechanism 60a is configured to perform delivery of component AR0 to be used in substrate work machine WM0 that performs a predetermined substrate work on a substrate. Delivery mechanism 60a corresponds to loading platform 62 already described.

Loading platform 62 is provided at the upper portion of carriage main body section 61, and can be loaded with component AR0. Loading platform 62 can also be loaded with accommodation case AC0 capable of accommodating component AR0. Loading platform 62 includes multiple rollers 62a, and can convey in component AR0 or accommodation case AC0 to station 50s and convey out component AR0 or accommodation case AC0 from station 50s. Loading platform 62 can also convey in component AR0 or accommodation case AC0 directly to substrate work machine WM0, and can directly convey out component AR0 or accommodation case AC0 from substrate work machine WM0.

Coupling mechanism 60b is a mechanism configured to be mechanically coupled to towing device 70, For example, as illustrated in FIG. 4, coupling mechanism 60b is disposed between bottom plate 64 at the lower portion of loading platform 62 and the upper surface of towing device 70. As already described, coupling mechanism 60b is configured to couple carriage main body section 61 to towing device 70 that has entered below carriage main body section 61 so as to be able to tow carriage main body section 61. Coupling mechanism 60b includes multiple (for example, three) coupling pins provided on the upper surface of towing device 70, and advancing direction-side locking member 65 provided on bottom plate 64 of loading platform 62.

Multiple coupling pins include, for example, one advancing direction-side coupling pin 71 provided on the advancing direction side of carriage 60 and towing device 70, and two retreating direction-side coupling pins 72 provided on the retreating direction side of carriage 60 and towing device 70. Advancing direction-side locking member 65 can lock advancing direction-side coupling pin 71 when advancing direction-side coupling pin 71 enters the advancing direction side from the retreating direction side. Therefore, when towing device 70 enters below carriage main body section 61, towing device 70 is allowed to enter the advancing direction side from the retreating direction side, and is restricted from entering the retreating direction side from the advancing direction side.

As already described, connecting portion 80c is a mechanism configured to be electrically connected to towing device 70. Connecting portion 80c is electrically connected to towing device 70 in accordance with the positioning and the coupling with towing device 70. As illustrated in FIG. 14, connecting portion 80c includes power connecting portion 80c1 and signal connecting portion 80c2. A power line capable of transmitting power to and from towing device 70 is connected to power connecting portion 80c1. As a result, for example, the driving power can be supplied by the battery of towing device 70 to carriage 60, and carriage 60 does not need to be loaded with the driving power battery. Carriage 60 can cause various mechanisms to be operated using the driving power supplied by towing device 70. For example, carriage 60 can cause delivery mechanism 60a to be operated using the driving power supplied by towing device 70.

A signal line capable of transmitting a control signal to and from towing device 70 is connected to signal connecting portion 80c2. Signal connecting portion 80c2 is electrically connected to towing device 70, thereby enabling the worker to operate towing device 70. For example, carriage 60 and towing device 70 each include an emergency stop button. When signal connecting portion 80c2 is electrically connected to towing device 70, the stop operation of the emergency stop button of towing device 70 is activated in accordance with the operation of the emergency stop button of carriage 60. The already described matters of component conveyance device 80 can be similarly applied to carriage 60. In addition, the above description of carriage 60 can be similarly applied to component conveyance device 80.

### 1-5. Method for Coupling Carriage 60 and Towing Device 70

The method for coupling carriage 60 and towing device 70 is a method for coupling carriage 60 that conveys component AR0 to be used in substrate work machine WM0 that performs a predetermined substrate work on a substrate, and towing device 70 that is capable of towing carriage 60 and automatically moving along a traveling path, and includes a first positioning step and a coupling and connection step. The method for coupling carriage 60 and towing device 70 is executed, for example, according to the flowchart illustrated in FIG. 15. In the first positioning step, the process illustrated in step SP1 is performed. In the coupling and connection step, the process illustrated in step SP2 is performed.

In the first positioning step, a first-stage positioning is performed with respect to carriage 60 (step SP1). The first positioning step is performed by, for example, coupling mechanism 60b already described. Accordingly, rough positioning between carriage 60 and towing device 70 is performed. The coupling and connection step, after the first positioning step is performed, operates moving mechanism 100, thereby performing mechanical positioning and coupling, and electrically connects carriage 60 and towing device 70 in accordance with the positioning and the coupling between carriage 60 and towing device 70 (step SP2), In other words, the coupling and connection step is the same as the control by component conveyance device 80. As already described, a slight misalignment between first connecting portion 80a and second connecting portion 80b can be eliminated by the floating connector.

In order for relative movement to occur between carriage 60 and towing device 70, it is necessary to release the lock of the wheels on second device 82 side. In the embodiment, second device 82 is carriage 60. Therefore, in the coupling and connection step, the lock of multiple (for example, four) wheels 63 of carriage 60 is released. After the end of the coupling and connection step, multiple (for example, four) wheels 63 of carriage 60 are locked. After the end of the coupling and connection step, carriage 60 and towing device 70 are clamped and integrally movable. When the coupling between carriage 60 and towing device 70 is released, the clamp between carriage 60 and towing device 70 is released, and carriage 60 and towing device 70 are individually movable.

The already described matters of component conveyance device 80 and carriage 60 can be similarly applied to the method for coupling carriage 60 and towing device 70. The above description of the method for coupling carriage 60 and towing device 70 can be similarly applied to component conveyance device 80 and carriage 60.

### 2. Example of Effect of Embodiment

With component conveyance device 80 described above, it is possible to electrically connect carriage 60 and towing device 70 in accordance with positioning and coupling between carriage 60 and towing device 70. The above description of component conveyance device 80 can be similarly applied to carriage 60 and a method for coupling carriage 60 and towing device 70,

### Reference Signs List

60; carriage, 60a: delivery mechanism, 60b; coupling mechanism, 70; towing device,
80; component conveyance device, 80a: first connecting portion, 80b: second connecting portion,
80c: connecting portion, 80c1: power connecting portion, 80c2: signal connecting portion,
80p: plane, 81: first device, 82: second device, 91; positioning portion,
91a: protrusion portion, 91b: plate-shaped member, 92: positioned portion, 92a: hole portion,
92b: recessed portion, 93; contact surface, 94: inclined surface, 95: base member,
100; moving mechanism, AR0; component, WM0: substrate work machine.

1. A component conveyance device comprising:
a carriage configured to convey a component to be used in a substrate work machine configured to perform a predetermined substrate work on a substrate;
a towing device configured to tow the carriage; and
a connecting portion configured to electrically connect the carriage and the towing device in accordance with positioning and coupling between the carriage and the towing device.

2. The component conveyance device according to claim 1,
wherein a first device, which is one of the carriage and the towing device, includes a positioning portion that positions a second device, which is the other of the carriage and the towing device,
the second device includes a positioned portion that is positioned by the positioning portion of the first device,
the first device or the second device includes a moving mechanism configured to move the positioned portion along a contact surface between the positioning portion and the positioned portion by causing relative movement between the positioning portion and the positioned portion, thereby performing the positioning and the coupling,
the connecting portion includes
a first connecting portion provided in the first device, and
a second connecting portion provided in the second device, and
the moving mechanism is configured to position and connect the first connecting portion and the second connecting portion by the relative movement between the positioning portion and the positioned portion.

3. The component conveyance device according to claim 2, wherein an inclined surface that guides the relative movement between the positioning portion and the positioned portion is formed on at least one of the positioning portion and the positioned portion.

4. The component conveyance device according to claim 3,
wherein the positioned portion is a hole portion provided in an outer plate of the second device,
the positioning portion is a protrusion portion capable of fitting into the hole portion, and
the moving mechanism is configured to move a first one of the protrusion portion or a base member on which the protrusion portion is fixed, and the hole portion toward a second one thereof to fit the protrusion portion into the hole portion, thereby performing the positioning and the coupling.

5. The component conveyance device according to claim 3,
wherein the positioned portion is a recessed portion provided in an outer peripheral portion of the second device,
the positioning portion is a plate-shaped member capable of coming into surface contact with the recessed portion, and
the moving mechanism is configured to move a first one of the plate-shaped member and the recessed portion with respect to a second one thereof while bringing the plate-shaped member and the recessed portion into surface contact with each other, thereby performing the positioning and the coupling.

6. The component conveyance device according to claim 2,
wherein the positioning portion and the positioned portion are provided in multiple sets, and
the multiple sets of the positioning portion and the positioned portion are evenly arranged around the connecting portion.

7. The component conveyance device according to claim 6, wherein the positioning portion and the positioned portion are provided in three or more sets.

8. The component conveyance device according to claim 2, wherein the connecting portion is a floating connector in which the first connecting portion is fixed to the first device so as not to be relatively movable, and the second connecting portion is fixed to the second device so as to be relatively movable with respect to a plane perpendicular to a connection direction with the first connecting portion.

9. A carriage, comprising:
a delivery mechanism configured to perform delivery of a component to be used in a substrate work machine configured to perform a predetermined substrate work on a substrate;
a coupling mechanism configured to be mechanically coupled to a towing device; and
a connecting portion configured to be electrically connected to the towing device,
wherein the connecting portion is electrically connected to the towing device in accordance with positioning and coupling with the towing device.

10. The carriage according to claim 9,
wherein the connecting portion includes
a power connecting portion to which a power line capable of transmitting power to and from the towing device is connected, and
a signal connecting portion to which a signal line capable of transmitting a control signal to and from the towing device is connected, and
the signal connecting portion is electrically connected to the towing device, thereby enabling a worker to operate the towing device.

11. A method for coupling a carriage configured to convey a component to be used in a substrate work machine configured to perform a predetermined substrate work on a substrate, and a towing device that is capable of towing the carriage and automatically moving along a traveling path, the method comprising:
a first positioning step of performing a first-stage positioning with respect to the carriage; and
a coupling and connection step of, after the first positioning step is performed, operating a moving mechanism, thereby performing mechanical positioning and coupling, and electrically connecting the carriage and the towing device in accordance with the positioning and the coupling between the carriage and the towing device.
